(19) United States
(12) Patent Application Publication
(10) Pub. No.: US 2008/0147371 A1
(43) Pub. Date: Jun. 19, 2008

(54) User Defined Virtual Instruments in a Simulation Environment

(76) Inventors: Kyle P. Gupton, Toronto (CA); Lingyun Pan, Toronto (CA); Rajesh S. Vaidya, Grosse Pointe Park, MI (US)

Correspondence Address: MEYERTONS, HOOD, KIVLIN, KOWERT & GOETZEL, P.C., P.O. BOX 398, AUSTIN, TX, 78767-0398, US

(21) Appl. No.: 11/609,928

(22) Filed: Dec. 13, 2006

(51) Int. Cl. G06F 17/50; G06F 3/048

(52) U.S. Cl. 703/14; 715/771

(57) ABSTRACT

A system and method for developing a virtual instrument for a simulation environment. First user input may be received to a graphical user interface (GUI) specifying functionality of the virtual instrument. The GUI may include a graphical programming development environment and the virtual instrument may include a graphical program. Second user input to the GUI specifying a graphical front panel of the virtual instrument may be received. The graphical front panel may allow a user to interact with the virtual instrument. A virtual instrument may be created in response to the first and second user input. The virtual instrument may be executable in the simulation environment to interact with a simulated circuit. The virtual instrument may be operable to interact with real world input/output.

### FIELD OF THE INVENTION

The present invention relates to the field of simulation, and more particularly to a system and method for creating user defined virtual instruments for a simulation environment.

### DESCRIPTION OF THE RELATED ART

Traditionally, high level text-based programming languages have been used by programmers in writing application programs. Many different high level text-based programming languages exist, including BASIC, C, C++, Java, FORTRAN, Pascal, COBOL, ADA, APL, etc. Programs written in these high level text-based languages are translated to the machine language level by translators known as compilers or interpreters. The high level text-based programming languages in this level, as well as the assembly language level, are referred to herein as text-based programming environments.

Increasingly, computers are required to be used and programmed by those who are not highly trained in computer programming techniques. When traditional text-based programming environments are used, the user's programming skills and ability to interact with the computer system often become a limiting factor in the achievement of optimal utilization of the computer system.

There are numerous subtle complexities which a user must master before he can efficiently program a computer system in a text-based environment. The task of programming a computer system to model or implement a process often is further complicated by the fact that a sequence of mathematical formulas, steps or other procedures customarily used to conceptually model a process often does not closely correspond to the traditional text-based programming techniques used to program a computer system to model such a process. In other words, the requirement that a user program in a text-based programming environment places a level of abstraction between the user's conceptualization of the solution and the implementation of a method that accomplishes this solution in a computer program. Thus, a user often must substantially master different skills in order to both conceptualize a problem or process and then to program a computer to implement a solution to the problem or process. Since a user often is not fully proficient in techniques for programming a computer system in a text-based environment to implement his solution, the efficiency with which the computer system can be utilized often is reduced.

To overcome the above shortcomings, various graphical programming environments now exist which allow a user to construct a graphical program or graphical diagram, also referred to as a block diagram. U.S. Pat. Nos. 4,901,221; 4,914,568; 5,291,587; 5,301,301; and 5,301,336; among others, to Kodosky et al disclose a graphical programming environment which enables a user to easily and intuitively create a graphical program. Graphical programming environments such as that disclosed in Kodosky et al can be considered a higher and more intuitive way in which to interact with a computer. A graphically based programming environment can be represented at a level above text-based high level programming languages such as C, Basic, Java, etc.

A user may assemble a graphical program by selecting various icons or nodes which represent desired functionality, and then connecting the nodes together to create the program. The nodes or icons may be connected by lines representing data flow between the nodes, control flow, or execution flow. Thus the block diagram may include a plurality of interconnected icons such that the diagram created graphically displays a procedure or method for accomplishing a certain result, such as manipulating one or more input variables and/or producing one or more output variables. In response to the user constructing a diagram or graphical program using the block diagram editor, data structures and/or program instructions may be automatically constructed which characterize an execution procedure that corresponds to the displayed procedure. The graphical program may be compiled or interpreted by a computer.

A graphical program may have a graphical user interface. For example, in creating a graphical program, a user may create a front panel or user interface panel. The front panel may include various graphical user interface elements or front panel objects, such as user interface controls and/or indicators that represent or display the respective input and output that will be used by the graphical program, and may include other icons which represent devices being controlled.

Thus, graphical programming has become a powerful tool available to programmers. Graphical programming environments such as the National Instruments LabVIEW product have become very popular. Tools such as LabVIEW have greatly increased the productivity of programmers, and increasing numbers of programmers are using graphical programming environments to develop their software applications. In particular, graphical programming tools are being used for test and measurement, data acquisition, process control, man machine interface (MMI), supervisory control and data acquisition (SCADA) applications, modeling, simulation, image processing/machine vision applications, and motion control, among others.

In parallel with the development of the graphical programming model, simulation environments have developed which allow users to simulate and interact with various systems. For example, some simulation packages allow users to generate various electrical systems, e.g., electrical circuits, and interact with those circuits in a simulation environment. More specifically, some of the packages may allow the user to design/create a circuit and then interact with that circuit using built-in instruments, such as an oscilloscope, to measure properties of the circuit during simulation. However, these simulation packages do not allow the user to create custom virtual instruments for the simulation environment.

### SUMMARY OF THE INVENTION

Various embodiments of a system and method for creating user defined virtual instruments for a simulation environment are presented below. As used herein, the term “virtual instrument” refers to a program having a corresponding user interface or front panel, wherein the user interface has input controls and output indicators for interactively setting values in and viewing output from the graphical program, respectively, while the program is executing.

The simulation environment may simulate systems, e.g., circuits, designed by a user. The method may allow a user to create a custom virtual instrument for the simulation environment, e.g., to interact with a designed circuit. The method may be used in conjunction with any of a variety of computer systems or devices. In various embodiments, some of the method elements shown may be performed concurrently, in a different order than shown, or may be omitted. Additional method elements may also be performed as desired. This method may operate as follows.

First user input may be received to a graphical user interface (GUI) specifying functionality of the virtual instrument. The GUI may be executing on a computer system and/or other electronic device. Additionally, the first user input to the GUI user input may include input to a programming development environment. More specifically, the virtual instrument may be a graphical program and the GUI may be a graphical programming development environment. Thus, the user specifying the first input may include the user assembling a plurality of nodes and interconnections, e.g., wires, between the nodes. The graphical program, e.g., the nodes and interconnections, may visually indicate functionality of the graphical program, which, in this case, may be (or be included in) the virtual instrument.

Alternatively, in one embodiment, the graphical program may be assembled automatically in response to the first user input. In other words, the first user input may generally specify functionality of the graphical program, e.g., to a wizard included in the GUI, and the GUI and/or other software may automatically generate a graphical program in response to the first user input.

The first user input may specify how the virtual instrument operates and/or interacts with systems, e.g., circuits, in a simulation environment. More specifically, the simulation environment may simulate the behavior of electronic circuits, e.g., designed by users, and the functionality described in the first user input may specify how the virtual instrument interacts with or displays data from the circuit.

For example, during execution in the simulation environment, the virtual instrument may provide data to the simulated circuit. In one embodiment the provided data may be from a physical system, e.g., from real world I/O. Additionally, or alternatively, the virtual instrument may display data regarding the simulated circuit during simulation, e.g., values derived from the data produced by the simulated circuit. Furthermore, the virtual instrument may be operable to provide the simulated data to real world I/O. Thus, in some embodiments, the virtual instrument, e.g., as specified by the first user input, may act as an interface between the simulation environment and physical systems. For example, as described above, the virtual instrument may be operable to receive data and provide that data to a physical system (or vice/versa). The physical system (e.g., the real world I/O) may include various measurement and/or automation systems, among others, as desired. Thus, the user may specify functionality of a virtual instrument which may interact with various systems, e.g., circuits, in a simulation environment.

Second user input may be received to the GUI specifying a graphical front panel of the virtual instrument. The front panel allows the user to interact with the virtual instrument, e.g., during simulation of the system. For example, the front panel may graphically indicate or display data received from the simulated system and/or data processed by the virtual instrument, e.g., the front panel may comprise graphs, charts, numeric displays, etc. In some embodiments, during simulation, the user may interact with the virtual instrument via the front panel. More specifically, the front panel may include dials, knobs, and/or sliders for inputting data, and/or other means for the user to interact with the virtual instrument. In some embodiments, these means may be used to interact with the simulated circuit itself, e.g., via the virtual instrument. For example, the front panel control(s) (e.g., dials, knobs, sliders, and/or other input controls) may include end-user configurable settings to control how the simulation environment interpolates the data that it sends to the instrument. These settings may include coerce, linear, and/or spline (among others) for interpolation methods and/or the sampling rate. Additionally, the interpolation methods may be specified by the user in the first user input, the second user input, and/or other inputs at various times (e.g., in the simulation environment).

Similar to above, the input may be received via a variety of methods, e.g., the user assembling the graphical front panel manually (e.g., graphically arranging icons or displays) and/or via a wizard which allows the user to specify the graphical front panel via one or more windows which request information from the user. Additionally, or alternatively, the graphical front panel may be included in or associated with a graphical program. As indicated above, further embodiments where the virtual instrument includes a graphical program are described below. Thus, the graphical front panel may allow the user to modify the behavior of the virtual instrument and/or the simulated system.

The virtual instrument may be created in response to the first and second user input. As indicated above, the virtual instrument may be executable in a simulation environment to interact with a simulated circuit, e.g., according to the first and second user input. The creation of the virtual instrument may involve automatic generation and/or compilation of code based on the first and second user input. For example, where the first user input and the second user input comprises graphical code, the generation of the virtual instrument may include compilation of that code. Additionally, or alternatively, where the first and second user input is more qualitative, e.g., where the user enters information into a virtual instrument graphical wizard, the creation of the virtual instrument may include automatic generation of the code (based on the first and second user input) and/or compilation of that code.

In some embodiments, the creation of the instrument may include packaging of the virtual instrument, e.g., in a specific file type or data structure (among others). For example, the virtual instrument may be generated as a DLL which may be read by the simulation environment; however, this particular type is exemplary only and other file types are envisioned.

Note that the GUI and the simulation environment may be independent of each other. For example, the GUI may be a graphical programming development environment (e.g., LABVIEW™ provided by National Instruments) and the simulation environment may be a separate circuit design and testing environment (e.g., MULTISIM™ also provided by National Instruments). In some embodiments the GUI may be used to develop virtual instruments for the simulation environment, but the GUI may not be required during execution of the virtual instruments. Thus, when the virtual instrument is created, the virtual instrument may be usable by the simulation environment without needing the GUI used to create the virtual instrument. In other words, the user may be able to load the virtual instrument even when the computer which stores the simulation environment does not include the development environment used to create the virtual instrument.

Thus, according to various embodiments, a virtual instrument may be created and may be executable in a simulation environment.

### BRIEF DESCRIPTION OF THE DRAWINGS

A better understanding of the present invention can be obtained when the following detailed description of the preferred embodiment is considered in conjunction with the following drawings, in which:

FIG. 1A illustrates a computer system that may implement an embodiment of the present invention;

FIG. 1B illustrates a network system comprising two or more computer systems that may implement an embodiment of the present invention;

FIG. 2A illustrates an instrumentation control system according to one embodiment of the invention;

FIG. 2B illustrates an industrial automation system according to one embodiment of the invention;

FIG. 3 is an exemplary block diagram of the computer systems of FIGS. 1A, 1B, 2A and 2B and 3B;

FIGS. 4-6 are flowchart diagrams illustrating embodiments of a method for creating (or executing) a virtual instrument for execution in a simulation environment; and

FIGS. 7-9 illustrate an exemplary virtual instrument, front panel, and circuit diagram according to one embodiment.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

### Incorporation by Reference:

The following references are hereby incorporated by reference in their entirety as though fully and completely set forth herein:

U.S. Pat. No. 4,914,568 titled “Graphical System for Modeling a Process and Associated Method,” issued on Apr. 3, 1990.

U.S. Pat. No. 5,481,741 titled “Method and Apparatus for Providing Attribute Nodes in a Graphical Data Flow Environment”.

U.S. Pat. No. 6,173,438 titled “Embedded Graphical Programming System” filed Aug. 18, 1997.

U.S. Pat. No. 6,219,628 titled “System and Method for Configuring an Instrument to Perform Measurement Functions Utilizing Conversion of Graphical Programs into Hardware Implementations,” filed Aug. 18, 1997.

U.S. Patent Application Publication No. 20010020291 (Ser. No. 09/745,023) titled “System and Method for Programmatically Generating a Graphical Program in Response to Program Information,” filed Dec. 20, 2000.

### Terms

The following is a glossary of terms used in the present application:

Memory Medium—Any of various types of memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various types of programmable hardware, reconfigurable hardware, programmable logic, or field-programmable devices (FPDs), such as one or more FPGAs (Field Programmable Gate Arrays), or one or more PLDs (Programmable Logic Devices), such as one or more Simple PLDs (SPLDs) or one or more Complex PLDs (CPLDs), or other types of programmable hardware. A programmable hardware element may also be referred to as “reconfigurable logic”.

Medium—includes one or more of a memory medium and/or a programmable hardware element; encompasses various types of mediums that can either store program instructions/data structures or can be configured with a hardware configuration program. For example, a medium that is “configured to perform a function or implement a software object” may be 1) a memory medium or carrier medium that stores program instructions, such that the program instructions are executable by a processor to perform the function or implement the software object; 2) a medium carrying signals that are involved with performing the function or implementing the software object; and/or 3) a programmable hardware element configured with a hardware configuration program to perform the function or implement the software object.

Program—the term “program” is intended to have the full breadth of its ordinary meaning. The term “program” includes 1) a software program which may be stored in a memory and is executable by a processor or 2) a hardware configuration program useable for configuring a programmable hardware element.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C++, Pascal, Fortran, Cobol, Java, assembly language, etc.; graphical programs (programs written in graphical programming languages); assembly language programs; programs that have been compiled to machine language; scripts; and other types of executable software. A software program may comprise two or more software programs that interoperate in some manner.

Hardware Configuration Program—a program, e.g., a netlist or bit file, that can be used to program or configure a programmable hardware element.

Graphical User Interface—this term is intended to have the full breadth of its ordinary meaning. The term “Graphical User Interface” is often abbreviated to “GUI”. A GUI may comprise only one or more input GUI elements, only one or more output GUI elements, or both input and output GUI elements.

The following provides examples of various aspects of GUIs. The following examples and discussion are not intended to limit the ordinary meaning of GUI, but rather provide examples of what the term “graphical user interface” encompasses:

A GUI may comprise a single window having one or more GUI Elements, or may comprise a plurality of individual GUI Elements (or individual windows each having one or more GUI Elements), wherein the individual GUI Elements or windows may optionally be tiled together.

A GUI may be associated with a graphical program. In this instance, various mechanisms may be used to connect GUI Elements in the GUI with nodes in the graphical program. For example, when Input Controls and Output Indicators are created in the GUI, corresponding nodes (e.g., terminals) may be automatically created in the graphical program or block diagram. Alternatively, the user can place terminal nodes in the block diagram which may cause the display of corresponding GUI Elements front panel objects in the GUI, either at edit time or later at run time. As another example, the GUI may comprise GUI Elements embedded in the block diagram portion of the graphical program.

Graphical User Interface Element—an element of a graphical user interface, such as for providing input or displaying output. Exemplary graphical user interface elements comprise input controls and output indicators

Input Control—a graphical user interface element for providing user input to a program. An input control displays the value input the by the user and is capable of being manipulated at the discretion of the user. Exemplary input controls comprise dials, knobs, sliders, input text boxes, etc.

Output Indicator—a graphical user interface element for displaying output from a program. Exemplary output indicators include charts, graphs, gauges, output text boxes, numeric displays, etc. An output indicator is sometimes referred to as an “output control”.

Front Panel—a graphical user interface having input controls and output indicators. The input controls in the front panel can be used to interactively set values in the graphical program while the graphical program is executing, and the output indicators can be used to view resultant output values from the graphical program while the graphical program is executing.

Virtual Instrument—a program and a corresponding front panel.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Measurement Device—includes instruments, data acquisition devices, smart sensors, and any of various types of devices that are operable to acquire and/or store data. A measurement device may also optionally be further operable to analyze or process the acquired or stored data. Examples of a measurement device include an instrument, such as a traditional stand-alone “box” instrument, a computer-based instrument (instrument on a card) or external instrument, a data acquisition card, a device external to a computer that operates similarly to a data acquisition card, a smart sensor, one or more DAQ or measurement cards or modules in a chassis, an image acquisition device, such as an image acquisition (or machine vision) card (also called a video capture board) or smart camera, a motion control device, a robot having machine vision, and other similar types of devices. Exemplary “stand-alone” instruments include oscilloscopes, multimeters, signal analyzers, arbitrary waveform generators, spectroscopes, and similar measurement, test, or automation instruments.

A measurement device may be further operable to perform control functions, e.g., in response to analysis of the acquired or stored data. For example, the measurement device may send a control signal to an external system, such as a motion control system or to a sensor, in response to particular data. A measurement device may also be operable to perform automation functions, i.e., may receive and analyze data, and issue automation control signals in response.

Real World I/O—data acquired from (“input”) a physical system, physical process, or unit under test (the “real world”) by a Measurement Device and/or data provided to (“output”) a physical system, physical process, or unit under test. Real World I/O may comprise real world input, real world output, or both. With respect to input, the term “real world I/O” refers to data acquired from a physical or “real world” system, as opposed to the computer generation of simulated input data. With respect to output, the term “real world I/O” refers to the provision of data generated by a program to a physical (real world) system or process.

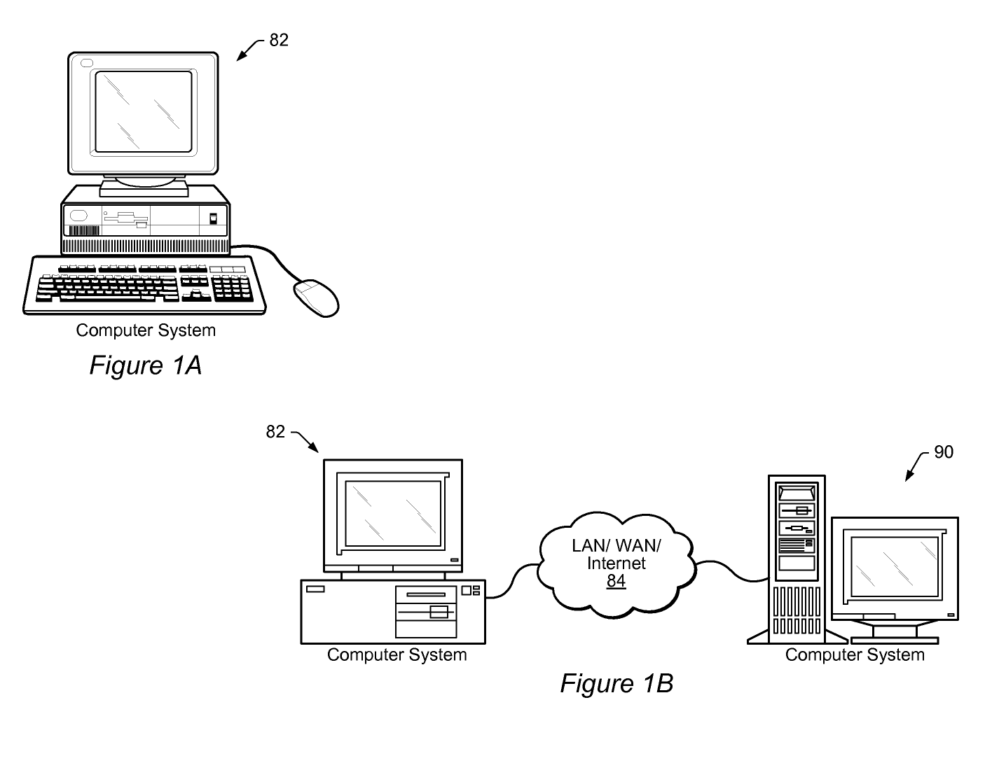

### FIG. 1A—Computer System

FIG. 1A illustrates a computer system 82 operable to allow a user to create user defined virtual instruments for a simulation environment.

As shown in FIG. 1A, the computer system 82 may include a display device operable to display the virtual instrument as the virtual instrument is created and/or executed. The display device may also be operable to display a graphical user interface or front panel of the virtual instrument during execution of the virtual instrument/simulation. The graphical user interface may comprise any type of graphical user interface, e.g., depending on the computing platform. Additionally, in some embodiments, the virtual instrument may be a graphical program.

The computer system 82 may include at least one memory medium on which one or more computer programs or software components according to one embodiment of the present invention may be stored. For example, the memory medium may store one or more graphical programs which are executable to perform the methods described herein. Additionally, the memory medium may store a graphical programming development environment application used to create and/or execute graphical programs. The memory medium may also store operating system software, as well as other software for operation of the computer system. Various embodiments further include receiving or storing instructions and/or data implemented in accordance with the foregoing description upon a carrier medium.

### FIG. 1B—Computer Network

FIG. 1B illustrates a system including a first computer system 82 that is coupled to a second computer system 90. The computer system 82 may be coupled via a network 84 (or a computer bus) to the second computer system 90. The computer systems 82 and 90 may each be any of various types, as desired. The network 84 can also be any of various types, including a LAN (local area network), WAN (wide area network), the Internet, or an Intranet, among others. The computer systems 82 and 90 may execute a graphical program in a distributed fashion. For example, computer 82 may execute a first portion of the block diagram of a graphical program and computer system 90 may execute a second portion of the block diagram of the graphical program. As another example, computer 82 may display the graphical user interface, e.g., a front panel, of a virtual instrument and computer system 90 may execute the remaining portion (e.g., the functionality) of the virtual instrument. Additionally, or alternatively, the simulation environment may be executed across one or more computer systems, e.g., the computer system 82 and the computer system 90.

In one embodiment, the front panel of the virtual instrument may be displayed on a display device of the computer system 82, and the remaining portion may execute on a device coupled to the computer system 82. The device may include a programmable hardware element and/or may include a processor and memory medium which may execute a real time operating system. In one embodiment, the virtual instrument may be downloaded and executed on the device. For example, an application development environment with which the virtual instrument is associated may provide support for downloading a virtual instrument for execution on the device in a real time system.

### Exemplary Systems

Embodiments of the present invention may be involved with performing test and/or measurement functions with simulated systems (e.g., circuits); controlling and/or modeling instrumentation or industrial automation hardware which may interact with simulations (e.g., circuit simulations); modeling and simulation functions, e.g., modeling or simulating a device or product being developed or tested, etc. Exemplary test applications where the virtual instrument may be used include hardware-in-the-loop testing and rapid control prototyping, among others.

However, it is noted that the present invention can be used for a plethora of applications and is not limited to the above applications. In other words, applications discussed in the present description are exemplary only, and the present invention may be used in any of various types of systems. Thus, the system and method of the present invention is operable to be used in any of various types of applications, including the control of other types of devices such as multimedia devices, video devices, audio devices, telephony devices, Internet devices, etc., as well as general purpose software applications such as word processing, spreadsheets, network control, network monitoring, financial applications, games, etc.

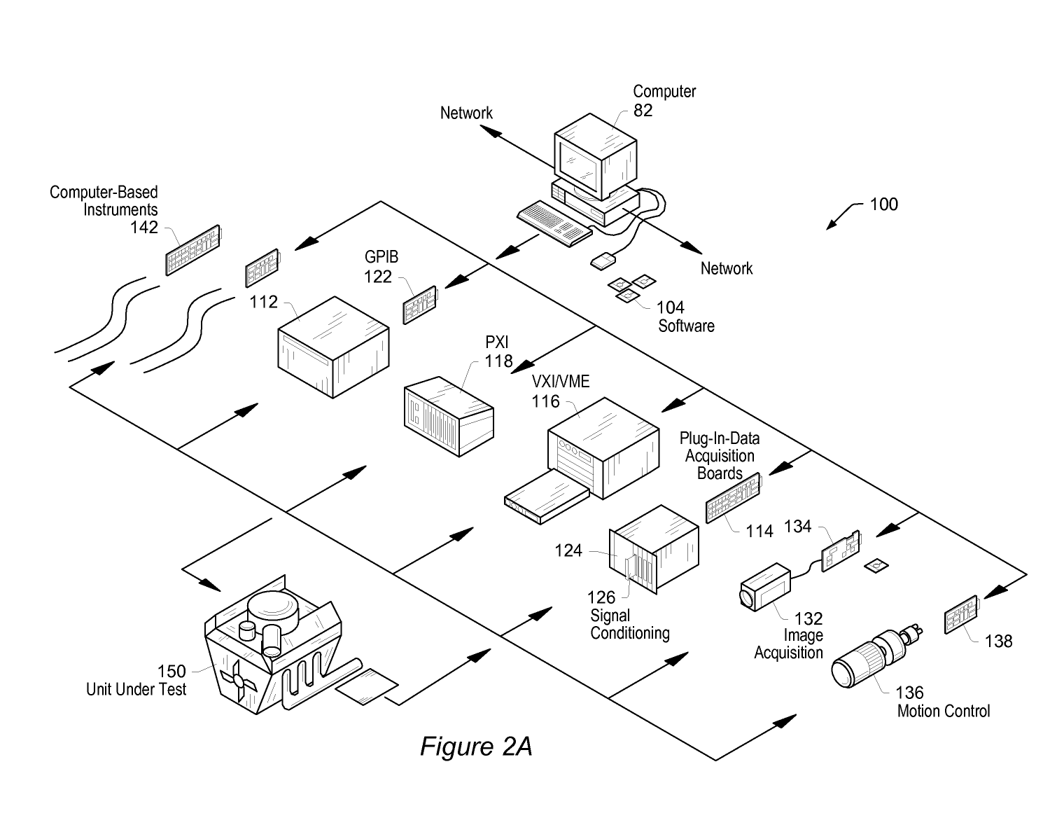

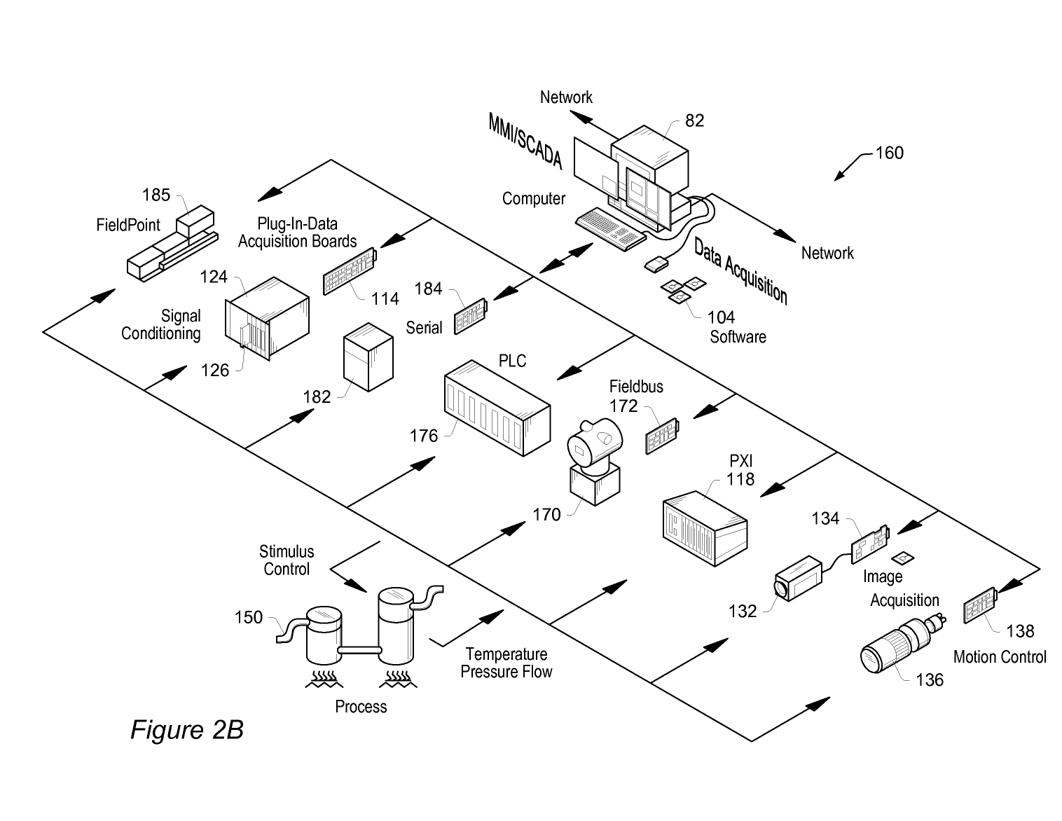

FIG. 2A illustrates an exemplary instrumentation control system 100 which may implement embodiments of the invention. The system 100 comprises a host computer 82 which couples to one or more instruments. The host computer 82 may comprise a CPU, a display screen, memory, and one or more input devices such as a mouse or keyboard as shown. The computer 82 may operate with the one or more instruments to analyze, measure or control a unit under test (UUT) or process 150.

The one or more instruments may include a GPIB instrument 112 and associated GPIB interface card 122, a data acquisition board 114 inserted into or otherwise coupled with chassis 124 with associated signal conditioning circuitry 126, a VXI instrument 116, a PXI instrument 118, a video device or camera 132 and associated image acquisition (or machine vision) card 134, a motion control device 136 and associated motion control interface card 138, and/or one or more computer based instrument cards 142, among other types of devices. The computer system may couple to and operate with one or more of these instruments. The instruments may be coupled to the unit under test (UUT) or process 150, or may be coupled to receive field signals, typically generated by transducers. The system 100 may be used in a data acquisition and control application, in a test and measurement application, an image processing or machine vision application, a process control application, a man-machine interface application, and/or a hardware-in-the-loop validation application, among others.

FIG. 2B illustrates an exemplary industrial automation system 160 which may implement embodiments of the invention. The industrial automation system 160 is similar to the instrumentation or test and measurement system 100 shown in FIG. 2A. Elements which are similar or identical to elements in FIG. 2A have the same reference numerals for convenience. The system 160 may comprise a computer 82 which couples to one or more devices or instruments. The computer 82 may comprise a CPU, a display screen, memory, and one or more input devices such as a mouse or keyboard as shown. The computer 82 may operate with the one or more devices to a process or device 150 to perform simulations which may implement and/or involve automation function(s), such as MMI (Man Machine Interface), SCADA (Supervisory Control and Data Acquisition), portable or distributed data acquisition, process control, advanced analysis, and/or other control, among others.

The one or more devices may include a data acquisition board 114 inserted into or otherwise coupled with chassis 124 with associated signal conditioning circuitry 126, a PXI instrument 118, a video device 132 and associated image acquisition card 134, a motion control device 136 and associated motion control interface card 138, a fieldbus device 170 and associated fieldbus interface card 172, a PLC (Programmable Logic Controller) 176, a serial instrument 182 and associated serial interface card 184, or a distributed data acquisition system, such as the Fieldpoint system available from National Instruments, among other types of devices.

In the embodiments of FIGS. 2A and 2B above, one or more of the various devices may couple to each other over a network, such as the Internet. In one embodiment, the user operates to select a target device from a plurality of possible target devices for programming or configuration using a graphical program and/or simulation environment, among others. Thus the user may create a virtual instrument on a computer and use (execute) the virtual instrument on that computer or deploy the virtual instrument to a target device (for remote execution on the target device) that is remotely located from the computer and coupled to the computer through a network. Similarly, the user may execute a simulation environment across multiple systems/devices using a network.

Graphical software programs which perform data acquisition, analysis and/or presentation, e.g., for measurement, instrumentation control, industrial automation, and/or modeling, such as in the applications shown in FIGS. 2A and 2B, may be referred to as virtual instruments. However, as used herein, the term virtual instrument is intended to include software entities which are operable to interact with a simulation environment, e.g., for simulating circuits. In preferred embodiments, as indicated above, the virtual instrument comprises a graphical program.

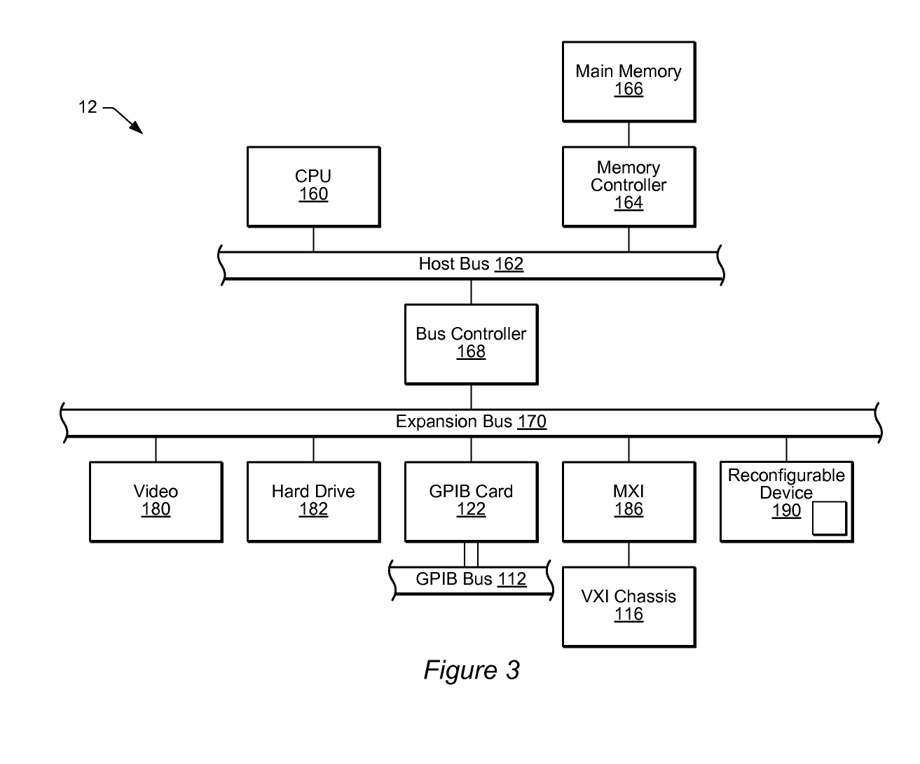

### FIG. 3—Computer System Block Diagram

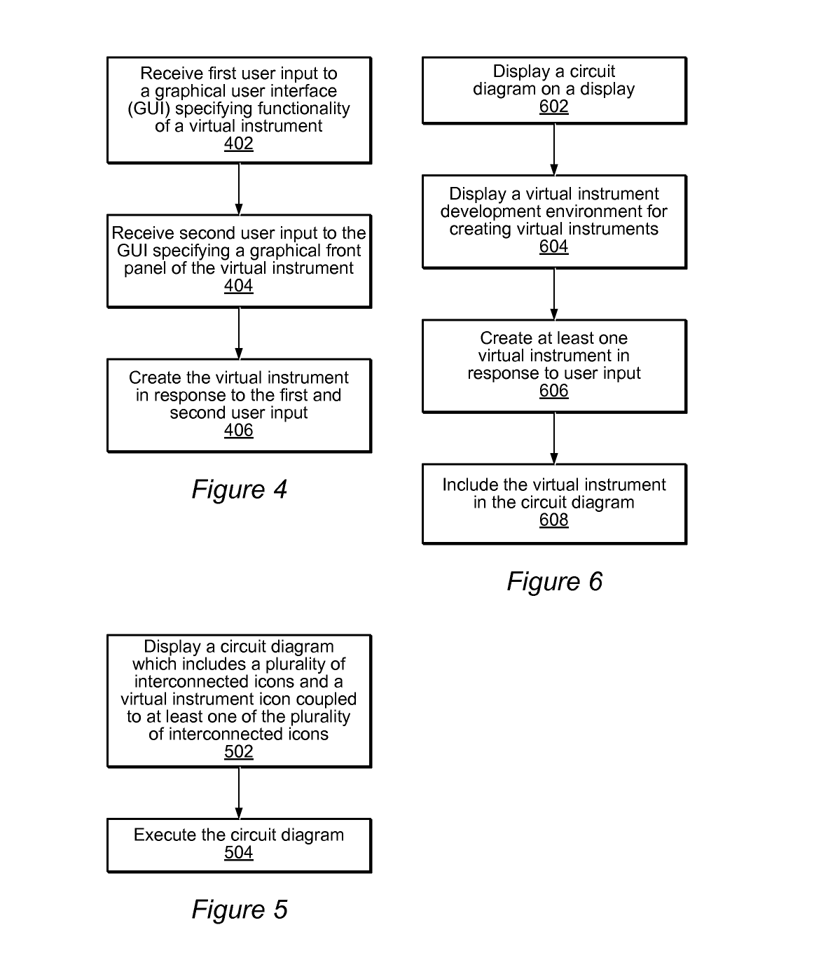

FIG. 3 is a block diagram representing one embodiment of the computer system 82 and/or 90 illustrated in FIGS. 1A and 1B, or computer system 82 shown in FIGS. 2A or 2B. It is noted that any type of computer system configuration or architecture can be used as desired, and FIG. 4 illustrates a representative PC embodiment. It is also noted that the computer system may be a general purpose computer system, a computer implemented on a card installed in a chassis, or other types of embodiments. Elements of a computer not necessary to understand the present description have been omitted for simplicity.

The computer may include at least one central processing unit or CPU (processor) 160 which is coupled to a processor or host bus 162. The CPU 160 may be any of various types, including an x86 processor, e.g., a Pentium class, a PowerPC processor, a CPU from the SPARC family of RISC processors, as well as others. A memory medium, typically comprising RAM and referred to as main memory, 166 is coupled to the host bus 162 by means of memory controller 164. The main memory 166 may store the graphical program operable to implement the virtual instrument(s) described herein. The main memory may also store operating system software, as well as other software for operation of the computer system.

The host bus 162 may be coupled to an expansion or input/output bus 170 by means of a bus controller 168 or bus bridge logic. The expansion bus 170 may be the PCI (Peripheral Component Interconnect) expansion bus, although other bus types can be used. The expansion bus 170 includes slots for various devices such as described above. The computer 82 further comprises a video display subsystem 180 and hard drive 182 coupled to the expansion bus 170.

As shown, a device 190 may also be connected to the computer. The device 190 may include a processor and memory which may execute a real time operating system. The device 190 may also or instead comprise a programmable hardware element. The computer system may be operable to deploy a virtual instrument (e.g., a graphical proram) to the device 190 for execution of the graphical program on the device 190. The deployed virtual instrument may take the form of virtual instrument instructions or data structures that directly represents the virtual instrument. Alternatively, the deployed virtual instrument may take the form of text code (e.g., C code) generated from the virtual instrument. As another example, the deployed virtual instrument may take the form of compiled code generated from either the virtual instrument or from the simulation environment and/or simulated circuit that the virtual instrument interacts with.

### FIG. 4—Flowchart

FIG. 4 is a flowchart illustrating an exemplary method for developing a virtual instrument for a simulation environment. The method shown in FIG. 4 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

In 402, first user input may be received to a graphical user interface (GUI) specifying program functionality of the virtual instrument. The GUI may be executing on the computer system 82 and/or another computing system. The program of the virtual instrument may be a text-based computer program or a graphical program. Thus, in some embodiments, the first user input to the GUI user input may include input to a graphical programming development environment. More specifically, in one embodiment, the virtual instrument may be a graphical program and the GUI may be a graphical programming development environment. Thus, the user specifying the first input may include the user assembling a plurality of nodes and interconnections, e.g., wires, between the nodes. The graphical program, e.g., the nodes and interconnections, may visually indicate functionality of the graphical program, which, in this case, may be (or be included in) the virtual instrument.

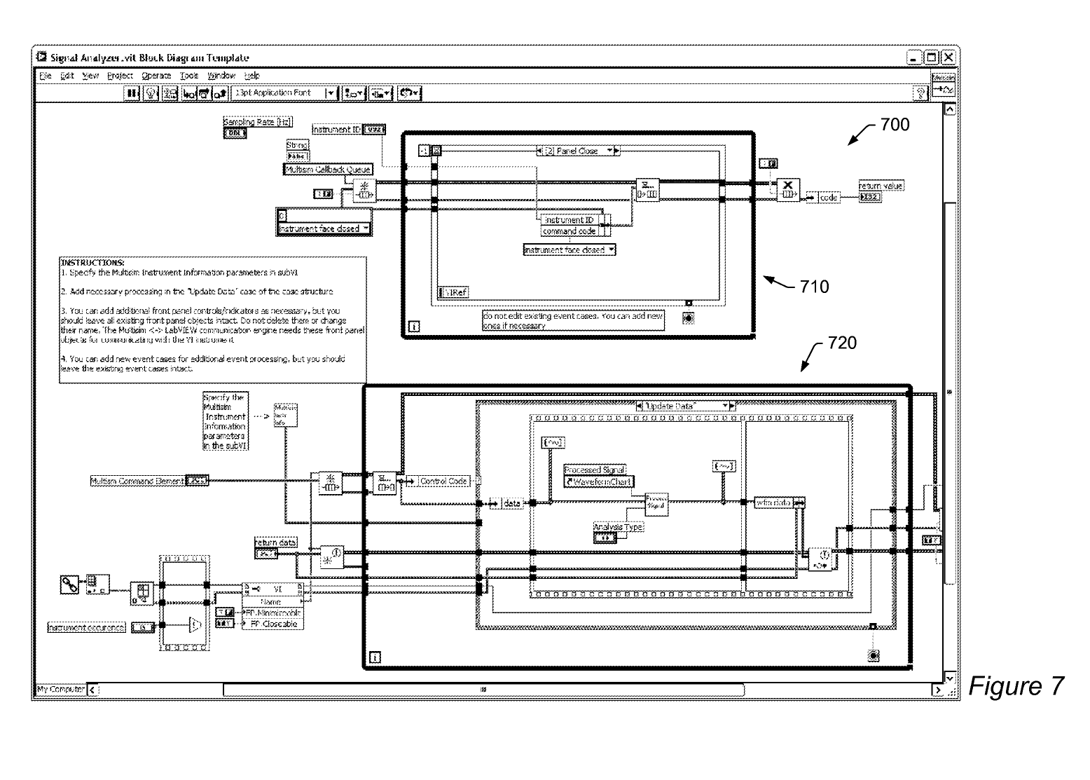

Alternatively, in one embodiment, the graphical program may be assembled automatically in response to the first user input. In other words, the first user input may generally specify functionality of the graphical program, e.g., to a wizard included in the GUI, and the GUI and/or other software may automatically generate a graphical program in response to the first user input. FIG. 7 illustrates an exemplary virtual instrument which is implemented as a graphical program and will be described in more detail below. Additionally, further descriptions where the virtual instrument is constructed as a graphical program are provided below. Additionally, any of the systems and methods described herein, e.g., those references incorporated by reference, may be used to generate the virtual instrument, e.g., as a graphical program.

In 404, second user input may be received to the GUI specifying a front panel of the virtual instrument. The front panel may allow the user to interact with the virtual instrument, e.g., during simulation of a system in the simulation environment. For example, the graphical front panel may allow the user to interact with the virtual instrument via the front panel as well as graphically indicate or display data received from the simulated system and/or data processed by the virtual instrument. More specifically, the front panel may include dials, knobs, and/or sliders for inputting data, and/or other means for the user to interact with the virtual instrument. In some embodiments, these means may be used to interact with the simulated circuit itself, e.g., via the virtual instrument. For example, the front panel control(s) (e.g., dials, knobs, sliders, and/or other input controls) may include end-user configurable settings to control how the simulation environment interpolates the data that it sends to the instrument. These settings may include coerce, linear, and/or spline (among others) for interpolation methods and/or the sampling rate. Additionally, the interpolation methods may be specified by the user in the first user input, the second user input, and/or other inputs at various times (e.g., in the simulation environment).

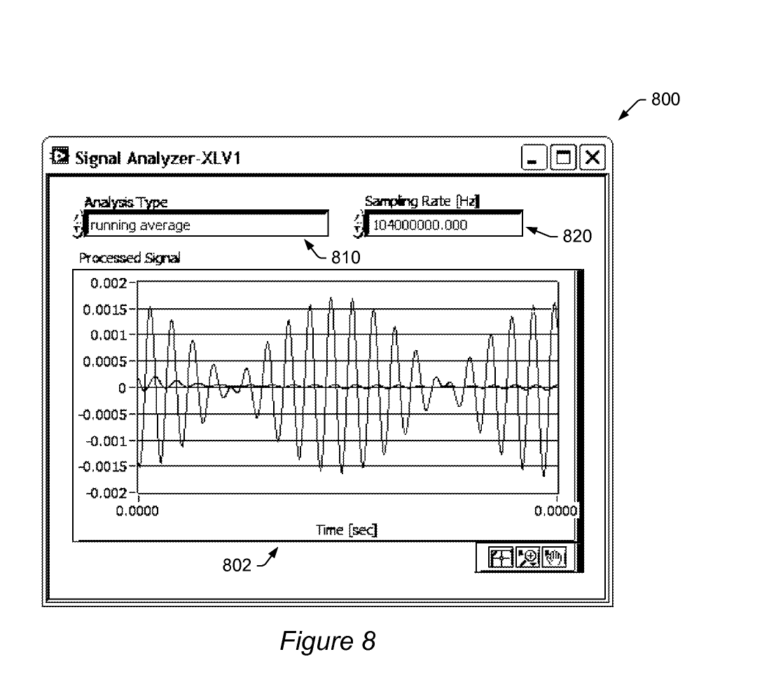

Similar to above, the input may be received via a variety of methods, e.g., the user assembling the graphical front panel manually (e.g., graphically selecting and arranging icons or displays) and/or via a wizard which allows the user to specify the graphical front panel via one or more windows which request information from the user. Additionally, or alternatively, the graphical front panel may be included in or associated with a graphical program. As indicated above, further embodiments where the virtual instrument includes a graphical program are described below. Additionally, FIG. 8 (described in more detail below) illustrates an exemplary virtual instrument front panel for the virtual instrument shown in FIG. 7. Thus, the graphical front panel may allow the user to modify the behavior of the virtual instrument and/or the simulated system.

Thus, as noted above, the virtual instrument (VI) may comprise a program and a front panel for interfacing with the program. The program portion of the virtual instrument may be written in textual code, or may be a graphical program. In one embodiment, the virtual instrument is a LabVIEW VI.

In some embodiments, the first user input may specify how the virtual instrument operates and/or interacts with systems, e.g., circuits, in a simulation environment. More specifically, the simulation environment may simulate the behavior of electronic circuits, e.g., designed by users, and the functionality described in the first user input may specify how the virtual instrument interacts with or displays data from the circuit.

For example, during execution in the simulation environment, the virtual instrument may provide data to the simulated circuit. In one embodiment the provided data may be from a physical system, e.g., from real world I/O. Additionally, or alternatively, the virtual instrument may display data regarding the simulated circuit during simulation, e.g., values derived from the data produced by the simulated circuit. Furthermore, the virtual instrument may be operable to provide the simulated data to real world I/O. Thus, in some embodiments, the virtual instrument, e.g., as specified by the first user input, may act as an interface between the simulation environment and physical systems. For example, as described above, the virtual instrument may be operable to receive data and provide that data to a physical system (or vice/versa). The physical system (e.g., the real world I/O) may include any of the systems described herein (such as the measurement and/or automation systems described above) or other systems, as desired. Thus, the first user input may specify how the virtual instrument may interact with a simulated system during execution (e.g., in the simulation environment).

More specifically, in some embodiments, the user input may specify the virtual instrument as an input instrument or an output instrument. If the user specifies an input instrument, the virtual instrument may receive simulation data for display or processing, similar to descriptions above. Where the user specifies an output instrument, the virtual instrument may generate data to use as a signal source for the simulation. In some embodiments, the virtual instrument may not be both an input instrument and an output instrument.

An input virtual instrument and an output virtual instrument may have different behaviors. For example, an input instrument may be operable to continuously receive simulation data from the simulation environment during execution. Additionally, input instruments may allow the user or creator of the virtual instrument to set a sampling rate, e.g., the first user input. The sampling rate may be the rate at which the virtual instrument receives data from the simulation environment. More specifically, the sampling rate may be analogous to the sampling rate that might have been set for real world I/O in physical systems. In general, the higher the sampling rate, the slower the simulation (e.g., of the circuit) will run. In some embodiments, the simulation data from the simulation environment may not be provided at a constant sampling rate, or may be provided at a rate that is not equal to the sampling rate. For example, the simulation environment may provide value time pairs as soon as the data is available. In such situations, it may be desirable to convert the provided data to a constant sampling rate. In some embodiments, this conversion may be performed by the virtual instrument and/or the simulation environment. Additionally, the conversion may be performed based on the specified sampling rate.

In contrast, an output virtual instrument may generate a finite amount of data and return that data to the simulation environment. The simulation environment may then use that data for simulation, e.g., of the circuit. In one embodiment, an output instrument may not continuously generate data while the simulation is running. For example, the output instrument may generate new data each time the simulation is restarted. Alternatively, the user may specify (e.g., in the first user input) that the data from the output instrument be repeated in a loop, e.g., continuously or for a specified number of times. Thus, the output virtual instrument may produce data (e.g., as received from a real world system) for the simulation environment until it no longer has data or may produce data continuously by repeating the stored data until the simulation stops. Where the virtual instrument outputs the data only once or a specified number of times, the virtual instrument's output may subsequently drop to zero while the simulation environment continues to execute. Thus, according to various embodiments, the virtual instrument may be an input or an output instrument as desired.

In some embodiments, the functionality of the virtual instrument(s) may be designed specifically for user defined circuit(s). In other words, a virtual instrument may be designed for a specific circuit. Alternatively, the virtual instrument(s) may be used generally across a variety of circuits in the simulated environment. For example, the virtual instrument may analyze spectral data of any type of circuit, e.g., similar to a spectrum analyzer. Thus, according to various embodiments, the virtual instrument may apply to circuits specifically or generically, as desired.

Thus, the user may specify functionality of a virtual instrument which may interact with simulated circuits in a simulation environment.

In 406, the virtual instrument may be created in response to the first and second user input. Step 406 may be performed substantially concurrently with the first and second user input provided in steps 402 and 404. In other words, as the user provides input in 402 and 404 to specify the virtual instrument, the virtual instrument is created in 406. As indicated above, the virtual instrument may be executable in a simulation environment to interact with a simulated circuit, e.g., according to the first and second user input. The creation of the virtual instrument may involve automatic generation and/or compilation of code based on the first and second user input. For example, where the first user input and the second user input comprises coding (e.g., graphical and/or textual code), the generation of the virtual instrument may include compilation of that code. Additionally, or alternatively, where the first and second user input is more qualitative, e.g., where the user enters information into a virtual instrument graphical wizard, the creation of the virtual instrument may include automatic generation of the code (based on the first and second user input) and/or compilation of that code.

In some embodiments, the creation of the instrument may include packaging of the virtual instrument, e.g., in a specific file type or data structure (among others). For example, the virtual instrument may be generated as a DLL which may be read by the simulation environment; however, this particular type is exemplary only and other file types are envisioned. Further details regarding a specific packaging of the virtual instrument into a DLL file are described below.

Note that the GUI and the simulation environment may be independent of each other. For example, the GUI may be a graphical programming development environment (e.g., LABVIEW™ provided by National Instruments) and the simulation environment may be a separate circuit design and testing environment (e.g., MULTISIM™ also provided by National Instruments). In some embodiments the GUI may be used to develop virtual instruments for the simulation environment, but the GUI may not be required during execution of the virtual instruments. Thus, when the virtual instrument is created, the virtual instrument may be usable by the simulation environment without needing the GUI used to create the virtual instrument. In other words, the user may be able to load the virtual instrument even when the computer which stores the simulation environment does not include the development environment used to create the virtual instrument. Specific embodiments describing the virtual instrument and the simulation environment are provided below.

### Graphical Program

In some embodiments, creating the virtual instrument may include creating a graphical program, e.g., one that implements the virtual instrument. In such embodiments, the GUI described above may be or include a graphical programming development environment, such as, for example, LabVIEW™ provided by National Instruments. The graphical program may be created on the computer system 82 (or on a different computer system). The graphical program may be created or assembled by the user arranging on a display a plurality of nodes or icons and then interconnecting the nodes to create the graphical program. In response to the user assembling the graphical program (e.g., as first user input), data structures may be created and stored which represent the graphical program. The nodes may be interconnected in one or more of a data flow, control flow, or execution flow format. The graphical program may thus include a plurality of interconnected nodes or icons which visually indicates the functionality of the program. As noted above, the graphical program may comprise a block diagram and may also include a user interface portion or front panel portion (e.g., as specified by the second user input). Where the graphical program includes a user interface portion, e.g., the graphical front panel described above, the user may optionally assemble the user interface on the display. As one example, the user may use the LabVIEW™ graphical programming development environment to create the graphical program.

In an alternate embodiment, the virtual instrument may be created, e.g., as a graphical program, by the user creating or specifying properties for the virtual instrument, followed by automatic or programmatic creation of the virtual instrument from the specification. For example, in U.S. patent application Ser. No. 09/587,682 titled “System and Method for Automatically Generating a Graphical Program to Perform an Image Processing Algorithm”, a graphical program may be automatically generated in response to input specifying a prototype. The above referenced U.S. Patent Application is hereby incorporated by reference in its entirety as though fully and completely set forth herein. Additionally, or alternatively, the graphical program may be created in other manners, either by the user or programmatically, as desired. Thus, according to various embodiments, the virtual instrument may include a graphical program which may be created via a variety of methods, as desired.

### Specific Embodiments of the Virtual Instrument

The following descriptions are provided as specific embodiments of the virtual instrument(s) described above. As indicated, these are exemplary only and are not intended to limit the invention in any way whatsoever; in fact, other embodiments and implementations of the virtual instrument(s) are envisioned.

In some embodiments, the virtual instrument may include a virtual instrument template and a hierarchy of components (e.g., sub-virtual instruments), a portion of which that may serve as the graphical front panel of the instrument. One or more of the template or the hierarchy may be generated in response to the first and second user input as indicated in 406. Additionally, as used herein, sub-virtual instruments are intended to include virtual instruments that are included in the virtual instrument. In some embodiments, the sub-virtual instrument may be another virtual instrument that is included in the virtual instrument as an icon which links to or represents the other virtual instrument.

The template diagram may contain all the necessary code for the virtual instrument to communicate data and/or status information with the simulation environment. The template diagram may also include code for the implementation of the instrument functionality (e.g., as specified in the first user input above). Additionally, the virtual instrument may contain in its hierarchy of components a collection of data which defines attributes of the virtual instrument. The attributes may include an instrument ID, a display name, the number of input pins (e.g., ports for transmitting/receiving data), the names of the input pins, the number of output pins, the names of the output pins, and/or the instrument version, among others.

In some embodiments, the interface between the simulation environment and the virtual instrument may be a DLL file created in the virtual instrument development environment. This instrument interface DLL file may manage the state of the active virtual instrument(s) and the passing of data and status information between the simulation environment and any active virtual instruments. In one embodiment, there may be one interface DLL for each version of the virtual instrument development environment.

Each instrument interface DLL file may support one or more of the following operations which may map directly to exported functions from the DLL.
Initialize—Do any initialization of the interface DLL necessary.
Close—Do any cleanup of the interface DLL necessary before unloading.
Get Icon—Get the icon for a specific virtual instrument.
Get Instrument ID List—Get the list of valid virtual instruments that the particular interface DLL supports.
Get Pin Info—Get the input and output pin information for a virtual instrument.
Create Instrument Instance—Create a new instance of a virtual instrument.
Destroy Instrument Instance—Destroy instance of a virtual instrument.
Get Instrument Instance Status—Get the status of a particular instance of a virtual instrument.
Show Instrument Instance—Show the graphical front panel of a particular instance of a a virtual instrument.
Refresh Instrument Instance—Clear data for a particular instance of a virtual instrument.
Serialize Data—Save any instance-specific state information with the file for the simulation diagram that contains a particular instance of a virtual instrument.
Deserialize Data—Gets any instance-specific state information that is saved with the file for the simulation diagram that contains a particular instance of a virtual instrument.
Update Data—Send new simulation data to a particular instance of a virtual instrument.
Update Data Begin—Inform a particular instance of a virtual instrument that simulation has started.
Update Data End—Inform a particular instance of a virtual instrument that simulation has stopped.
Update Data Recycle—Instruct a particular instance of a virtual instrument to clear any cached data.
Update Data Get Interpolation Method—Get the simulation data interpolation method to use for a particular instance of a virtual instrument.
Update Data Get t0—Get the beginning time step to use for simulation data sent to a particular instance of a virtual instrument.
Update Data Get dT—Get the sampling period to use for simulation data sent to a particular instance of a virtual instrument.
Update Data Get Data—Get output data from a particular instance of a virtual instrument.
Update Data Initial Output Pin Data—Get the initial output data from a particular instance of a virtual instrument.

In one embodiment, the virtual instrument may include an LLB (library) file of the virtual instrument. This file may include a virtual instrument library which includes one or more templates (such as those indicated above, among others) and any virtual instruments that are part of the template hierarchies (e.g., those in a virtual instrument library that are referenced as well as all unreferenced virtual instrument that are stored in libraries that are part of the hierarchy of the template). The virtual instrument may also include a folder containing any non-virtual instrument dependencies of the template. For example, these may include menu files, DLLs, and/or other files (e.g., from the virtual instrument development environment).

Simulation data may be passed to the virtual instrument via a variety of mechanisms. As indicated above, the virtual instrument may generally expect the simulation data to come at a given rate, e.g., a sampling rate; however, the simulation data may be produced in time-value pairs that are not evenly spaced. As a result, the data may be transformed into evenly spaced time-value pairs so that the virtual instrument may properly interact with the simulation data. In some embodiments, the simulation environment may perform this transformation, e.g., according to the interpolation settings specified on the panel(s) of the virtual instrument (e.g., in the first and/or second user input). Thus, the virtual instrument may be packaged and implemented via the specific method described above; however, other embodiments are envisioned.

### FIG. 5—Executing a Circuit Diagram

FIG. 5 is a flowchart illustrating an exemplary method for executing a circuit diagram which includes a virtual instrument. The method shown in FIG. 5 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

In 502, a circuit diagram may be displayed on a display, e.g., of the computer system 82, in response to user input. The circuit diagram may include a plurality of interconnected icons and each of the icons may correspond to a circuit element. The circuit diagram may include a virtual instrument icon coupled to at least one of the icons in the circuit diagram. The virtual instrument icon may represent a virtual instrument, e.g., similar to the virtual instruments described above. Additionally, the user may have created the virtual instrument in the virtual instrument development environment using the method described in FIG. 4. Additionally, or alternatively, the virtual instrument may include a graphical program and may be created via the methods described above, among others. In one embodiment, the virtual instrument may be executable to interface to real world I/O, e.g., of physical systems such as those described above, among others.

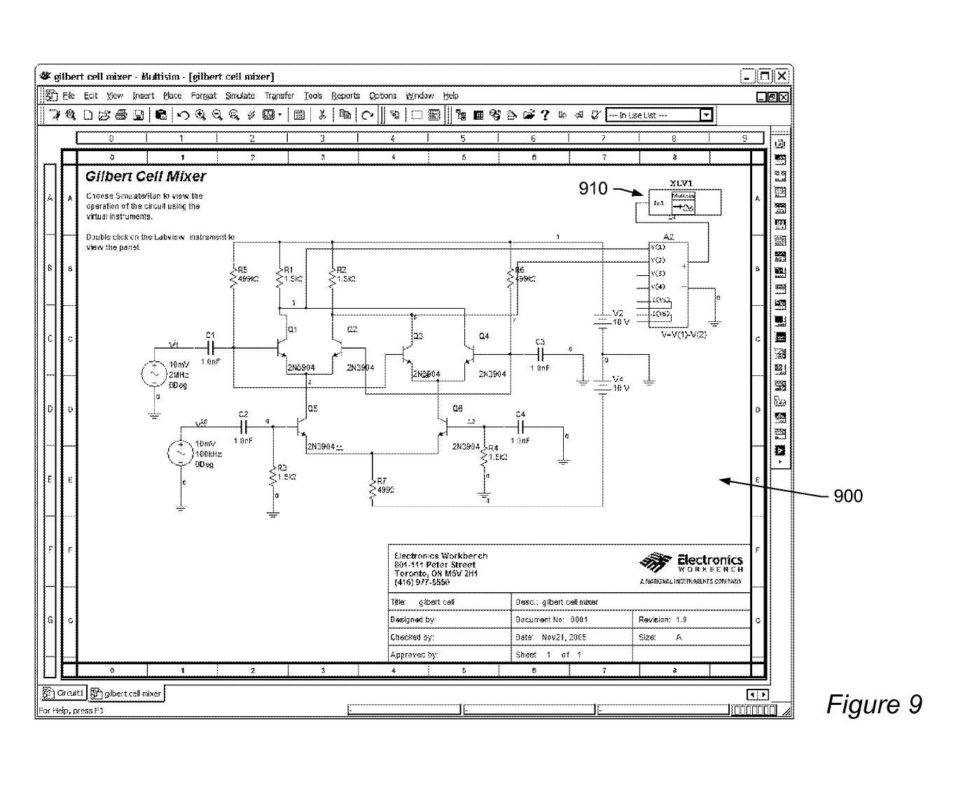

In some embodiments, the user input may include configuring or assembling the circuit diagram manually. For example, the user may be able to drag and drop circuit elements from a palette on a GUI in the simulation environment. The user may also connect these icons to form a circuit diagram. Additionally, or alternatively, the user may create the circuit diagram via other methods. For example, the user may input criteria or otherwise specify functionality of the circuit diagram to a GUI, and in response to the user input, the circuit diagram may be automatically created. However, in one embodiment, the user input may simply open a previously generated or specified circuit diagram. Note that other inputs are envisioned. Thus, the circuit diagram may be displayed in response to various user inputs. FIG. 9 (described in more detail below) illustrates an exemplary circuit diagram which includes a virtual instrument icon according to one embodiment.

In 504, the circuit diagram may be executed, e.g., in the simulation environment. During execution, the virtual instrument (represented by the virtual instrument icon) may be operable to interact with the simulated circuit. In one embodiment, during execution, the virtual instrument may be operable to provide real world I/O to/from the simulated circuit. In particular, the virtual instrument icon may provide real world I/O to/from the plurality of connected icons (e.g., the circuit elements in the circuit). Additionally, or alternatively, the virtual instrument may allow the user to interact with the simulation during execution. Thus, during execution the virtual instrument may operate to interact with the simulated circuit, e.g., to provide and/or receive data to/from real world I/O.

### FIG. 6—Developing a Virtual Instrument for a Simulation Environment

FIG. 6 is a flowchart illustrating an exemplary method for developing a virtual instrument for a simulation environment. The method shown in FIG. 6 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

In 602, a circuit diagram may be displayed on a display (e.g., of the computer system 82) in response to user input. As described above (e.g., with respect to FIG. 5), the circuit diagram may include a plurality of connected icons which may each correspond to a circuit element.

In 604, a virtual instrument development environment for creating virtual instruments may be displayed. Similar to descriptions above, the virtual instrument development environment may include the GUI described in FIG. 4.

In 606, at least one virtual instrument may be created in response to user input to the virtual instrument development environment. Similar to the descriptions with regard to FIG. 4, the at least one virtual instrument may be created in response to user input which specifies functionality of the virtual instrument and a front panel for the virtual instrument. The virtual instrument may be executable to interface to real world I/O (e.g., the physical systems described above, among others). Additionally, the virtual instrument may be specific to the circuit diagram displayed in 602 or may be a general virtual instrument which is usable in a plurality of circuit diagrams.

In 608, the virtual instrument may be included in the circuit diagram (e.g., represented with a virtual instrument icon). As indicated above, FIG. 9 illustrates an exemplary circuit diagram which includes a virtual instrument icon. Similar to the descriptions above in FIG. 5, during execution of the circuit diagram, the at least one virtual instrument may be operable to display signals generated in the circuit diagram. Additionally, or alternatively, the user may be able to interact with the circuit diagram using the virtual instrument (e.g., the front panel of the virtual instrument). Thus, according to various embodiments, a virtual instrument may be created, included in a circuit diagram, and executed in a simulation environment.

### Exemplary Instrument and Simulated Circuit

FIGS. 7-9 illustrate an exemplary virtual instrument (with front panel) and simulated circuit following various embodiments described above. Note that this virtual instrument, front panel, and simulated circuit are not intended to limit the invention at all and are exemplary only. In other words, other virtual instruments, front panels, and simulated circuits are envisioned.

As shown, FIG. 7 illustrates an exemplary virtual instrument 700 which includes a graphical program. More specifically, the virtual instrument 700 is a signal analyzer which operates to analyze signals in an electronic circuit. The interconnected nodes shown in the Figure represent a portion of the graphical program. In other words, FIG. 7 illustrates a portion of the graphical source code, or block diagram, of the signal analyzer. This source code may implement both the functionality required to exchange data and status information with the simulation environment as well as the specific signal analysis function of the virtual instrument 700 (e.g., the signal analyzer). As shown, graphical while loop 710 and graphical while loop 720 include the main structure of the virtual instrument 700. The graphical while loop 710 may implement a queue-based mechanism for communicating status information (e.g., panel open, panel close, etc.) between the simulation environment and the virtual instrument 700 via an instrument interface DLL. The graphical while loop 720 may implement a queue-based mechanism for exchanging simulation data between the simulation environment and the virtual instrument 700 via an instrument interface DLL, as well as the signal analysis functionality of the virtual instrument 700. Thus, FIG. 7 illustrates at least a portion of the virtual instrument 700.

As shown, FIG. 8 illustrates an exemplary front panel 800 for the virtual instrument 700. In the front panel, the user may change the sampling rate, e.g., via the numeric control shown, and/or various other features of the virtual instrument using the controls on the front panel. As shown, the front panel 800 may display (e.g., in window 802) the time-domain analog voltage input signal, the auto-power spectrum of the input signal, or the running average of the input signal. Additionally, the user may interact with the graphical front panel by changing analysis type control 810 and/or sampling rate control 820. Before beginning simulation, the simulation environment may read the value in sampling rate control 820 of a particular instance of the instrument via an instrument interface DLL. The simulation environment may use this information to determine the sampling rate to use when transforming the simulation data into evenly spaced time-value pairs to send to the particular instance of the instrument via an instrument interface DLL. Thus, FIG. 8 illustrates an exemplary front panel of the virtual instrument 700.

As shown, FIG. 9 illustrates an exemplary circuit diagram 900 in the simulation environment. Additionally, as shown, the virtual instrument 700 may be represented by a virtual instrument icon 910. The virtual instrument icon allows the user to connect the circuit to the virtual instrument 700 (e.g., specific inputs and/or outputs of the virtual instrument 700). Thus, during execution, the virtual instrument 700 may receive voltage simulation data from the simulated circuit 900, e.g., according to the interconnections illustrated in the circuit diagram 900. Thus, FIG. 9 illustrates the exemplary circuit diagram 900 including the virtual instrument icon 910 which represents the virtual instrument 700.

Thus, FIGS. 7-9 are specific examples of a virtual instrument, front panel, and simulated circuit.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A computer-accessible memory medium comprising program instructions for executing a circuit diagram with a virtual instrument which provides real world input/output (I/O), wherein the memory medium is usable in a system comprising a display, wherein the program instructions are executable to:
display a circuit diagram on the display in response to user input, wherein the circuit diagram comprises a plurality of connected icons, wherein each of the icons corresponds to a circuit element;
display a first virtual instrument icon in the circuit diagram coupled to at least one of the plurality of connected icons, wherein the first virtual instrument icon represents a first virtual instrument, wherein the first virtual instrument comprises a program and a front panel, wherein the first virtual instrument is executable to interface to a physical system and provide real world I/O between the physical system and the circuit diagram.

2. The memory medium of claim 1, wherein the virtual instrument comprises a graphical program, wherein the graphical program comprises a plurality of connected nodes which visually indicate functionality of the graphical program.

3. The memory medium of claim 2,
wherein the graphical program is a data flow graphical program, wherein connections between nodes represent flow of data between the nodes.

4. The memory medium of claim 1, wherein the program instructions are further executable to:
display a virtual instrument development environment for creating virtual instruments; and
create at a first virtual instrument in response to user input to the virtual instrument development environment, wherein the first virtual instrument comprises a graphical user interface for displaying signals generated in the circuit diagram, wherein the at least one virtual instrument has an associated virtual instrument icon, and wherein the associated virtual instrument icon comprises the first virtual instrument icon.

5. The memory medium of claim 4, wherein the virtual instrument development environment comprises a graphical programming development environment, wherein the graphical programming development environment is operable to create graphical programs in response to user input, and wherein the graphical programs each comprise a plurality of interconnected nodes which visually indicate functionality of the graphical program.

6. The memory medium of claim 1, wherein the program instructions are further executable to:
execute the circuit diagram, wherein, in executing the circuit diagram, the program instructions are executable to:
execute the first virtual instrument to provide real world I/O between the physical system and the circuit diagram; and
display the front panel of the first virtual instrument, wherein the front panel of the first virtual instrument displays at least a portion of the real world I/O.

7. A computer-accessible memory medium comprising program instructions for developing a virtual instrument for a simulation environment, wherein the memory medium is usable in a system comprising a display, wherein the program instructions are executable to:
display a circuit diagram on the display in response to user input, wherein the circuit diagram comprises a plurality of connected icons, wherein each of the icons corresponds to a circuit element, wherein the circuit diagram represents a simulated circuit;
display a virtual instrument development environment for creating virtual instruments;
create at least one virtual instrument in response to user input to the virtual instrument development environment, wherein the at least one virtual instrument comprises a front panel for displaying signals generated in the circuit diagram, wherein the at least one virtual instrument has an associated virtual instrument icon; and
including the virtual instrument icon in the circuit diagram;
wherein during execution of the circuit diagram the front panel of the at least one virtual instrument is operable to receive user input to affect operation of the circuit diagram and display signals generated in the circuit diagram.

8. The memory medium of claim 7, wherein the at least one virtual instrument comprises a graphical program, wherein the graphical program comprises a plurality of interconnected nodes which visually indicate functionality of the graphical program.

9. The memory medium of claim 7, wherein the at least one virtual instrument is executable to interface to real world I/O.

10. The memory medium of claim 7, wherein the at least one virtual instrument includes instrument functionality specific to the circuit diagram.

11. The memory medium of claim 7, wherein to create the at least one virtual instrument in response to user input, the program instructions are executable to:
receive first user input to a graphical user interface (GUI) specifying functionality of the at least one virtual instrument;
receive second user input to the GUI specifying a graphical front panel of the at least one virtual instrument, wherein the graphical front panel allows a user to interact with the at least one virtual instrument; and
create the at least one virtual instrument in response to the first and second user input, wherein the at least one virtual instrument is executable in the simulation environment to interact with a simulated circuit.

12. A computer-accessible memory medium comprising program instructions for developing a virtual instrument for a simulation environment, wherein the memory medium is usable in a system comprising a display, wherein the program instructions are executable to:
receive first user input to a graphical user interface (GUI) specifying functionality of the virtual instrument;
receive second user input to the GUI specifying a graphical front panel of the virtual instrument, wherein the graphical front panel allows a user to interact with the virtual instrument;
create the virtual instrument in response to the first and second user input, wherein the virtual instrument is executable in the simulation environment to interact with a simulated circuit;
display a circuit diagram which includes a virtual instrument icon, wherein the virtual instrument icon represents the virtual instrument; and
simulate the circuit diagram, wherein during simulation the simulation environment executes the virtual instrument.

13. The memory medium of claim 12, wherein the GUI is a graphical program development environment usable to generate graphical programs, wherein the graphical programs each comprises a plurality of interconnected nodes which visually indicate functionality of the graphical program.

14. The memory medium of claim 12, wherein the virtual instrument comprises a graphical program, wherein the graphical program comprises a plurality of interconnected nodes which visually indicate functionality of the graphical program.

15. The memory medium of claim 12, wherein the simulation environment is independent of the GUI.

16. The memory medium of claim 12, wherein the program instructions are further executable to:
execute the virtual instrument in the simulation environment, wherein said executing comprises:
the virtual instrument interacting with the simulated circuit.

17. The memory medium of claim 16, wherein said executing the virtual instrument further comprises:
receiving data from a physical system, wherein the data from the physical system is usable by the simulated circuit during simulation.

18. The memory medium of claim 16, wherein said executing the virtual instrument further comprises:
displaying data regarding the simulated circuit during simulation.

19. The memory medium of claim 16, wherein said executing the virtual instrument further comprises:
the virtual instrument providing data to the simulated circuit during simulation.

20. The memory medium of claim 16, wherein said executing the virtual instrument further comprises:
receiving data from the simulated circuit; and
providing the data to a physical system.
